(19) United States
(12) Patent Application Publication
(10) Pub. No.: US 2006/0221825 A1
(43) Pub. Date: Oct. 5, 2006

(54) Congestion control network relay device and method

(75) Inventor: Tetsuya Okano, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/196,377

(22) Filed: Aug. 3, 2005

(30) Foreign Application Priority Data
Mar. 31, 2005 (JP) 2005-101162

(51) Int. Cl. H04J 3/22; H04L 12/26; H04L 1/00; H04J 3/16

(52) U.S. Cl. 370/229; 370/465

(57) ABSTRACT

A congestion control network relay device capable of preventing redundant retransmission of packets which are already delivered to a receiving-side device. When an acknowledgment packet is detected by an acknowledgment packet detector, a receive packet manager stores acknowledgment information in an acknowledgment information memory. If first and second data packets are retransmitted thereafter from a transmitting-side device and input to the congestion control network relay device, a packet reception determination unit judges, for example, that the first data packet has not yet been received by the receiving-side device while the second data packet has already been received by the receiving-side device. In this case, a packet transfer unit transfers the first data packet to the receiving-side device and discards the second data packet.

### CROSS-REFERENCE TO RELATED APPLICATIONS

This application is based upon and claims the benefits of priority from the prior Japanese Patent Application No. 2005-101162, filed on Mar. 31, 2005, the entire contents of which are incorporated herein by reference.

### BACKGROUND OF THE INVENTION

1. Field of the Invention

The present invention relates to congestion control network relay devices and methods for controlling network congestion, and more particularly, to congestion control network relay device and method for controlling retransmission of data at the time of congestion.

2. Description of the Related Art

Large-scale networks often include both wideband transmission paths and narrowband transmission paths. For example, some networks include high-speed transmission paths constituted by optical fibers, as well as low-speed transmission paths dedicated for radio communications.

In cases where wideband and narrowband transmission paths coexist, congestion is liable to occur when data which has been transmitted via a wideband transmission path passes through a narrowband transmission path. Congestion indicates a situation where increased network traffic makes it difficult to carry on effective communication.

Where packets to be communicated are assigned respective priority levels, a method (bandwidth control method) may be employed wherein, at the time of congestion, packets of high priority are preferentially transmitted while packets of low priority are discarded. However, if high-priority packets are transmitted in excess of the bandwidth allocated thereto, congestion of high-priority packets is still unavoidable.

FIG. 23 exemplifies conventional congestion control. In FIG. 23, packets being transmitted are indicated by circles, wherein the shaded circles denote packets which are to be preferentially transmitted (hereinafter referred to as priority packets) and the outline circles denote other packets.

A first state (ST1) is a state in which congestion has occurred. As illustrated, a large number of packets are flowing from a wideband transmission path 901 into a narrowband transmission path 902, causing congestion as a result. In the first state, no congestion control is performed, so that not a few packets fail to be transmitted (packets are discarded) irrespective of priority level.

A second state (ST2) is a state wherein congestion is avoided by bandwidth control. By performing the bandwidth control, it is possible to secure a given bandwidth for the priority packets, whereby the priority packets are prevented from being discarded.

There are other congestion control techniques than the bandwidth control. For example, a technique is known wherein, if the transfer of data fails due to deficiency of the space of a receiving buffer associated with a receiving-side node, the data is retransmitted after completion of the ongoing communication performed by the receiving-side node (cf. Unexamined Japanese Patent Publication No. H02-90751).

Also, there is known a technique for a data-relaying router wherein, if a packet fails to be held by the buffer of the router because of congestion and is discarded, packets received subsequently to the discarded packet are successively discarded (cf. Unexamined Japanese Patent Publication No. 2003-23443).

Thus, in the case of congestion, the transmitting-side node or the packet-relaying node may stop transmitting data to a congested node or network, to thereby mitigate the congestion.

However, if packets are discarded continuously until the congestion is resolved, as mentioned in Unexamined Japanese Patent Publications No. H02-90751 and No. 2003-23443, extra packets are generated by, for example, a process of retransmitting all discarded packets from the first one that failed to be received, which hinders effective use of resources such as network paths. As a result, the congestion may possibly become even worse or the quality of communication lowers. This problem also arises in cases where the bandwidth control is performed according to priority levels.

FIG. 24 illustrates a communication state during congestion control. Specifically, FIG. 24 shows a situation where duplicate retransmission packets have been generated as a result of congestion, eventually making it impossible to effectively use the bandwidth secured by the bandwidth control.

Even in the case where a bandwidth is secured for priority packets by the bandwidth control, congestion occurs if priority packets arrive in excess of the secured bandwidth, with the result that part of the priority packets are discarded. If data is discarded due to congestion, the receiving-side device repeatedly transmits an acknowledgment (ACK) packet acknowledging reception of data up to the one preceding the discarded data. On receiving the ACK packet of the same content three times, the transmitting-side device retransmits the discarded data packet as well as the following packets. Consequently, more data packets than actually acceptable flow through the transmission path 901, so that the bandwidth in terms of effective value of data transmission is narrowed by congestion.

In TCP (Transmission Control Protocol)/IP (Internet Protocol) communications, reception of packets is acknowledged to ensure reliable communication. The acknowledgment of reception is carried out in a manner such that in response to a received packet, the receiving side sends an acknowledgment packet to the transmitting side. The acknowledgment is often performed using SACK (Selective ACK) (RFC 2018), besides ordinary ACK.

ACK is information included in the flags of the TCP header format, and if the ACK flag is “1”, an acknowledgment number in the header is valid. The acknowledgment number is the sequence number of the last one of consecutive packets which the receiving side has properly received.

SACK is information set in the options field added to the TCP header. SACK is used for the notification of individual received packets in cases where a certain packet following a packet of which the reception has been acknowledged by ACK fails to reach (is lost) though the subsequent packet is received.

The use of SACK enables retransmission of lost packets, without entailing lowering of the transmission speed or redundant retransmission of packets. In the case of severer congestion, however, the beneficial function of SACK does not work effectively; on the contrary, the TCP congestion avoidance action is delayed by SACK, with the result that unnecessary retransmission packets are transmitted.

FIG. 25 exemplifies data transfer using SACK, wherein it is assumed that among No. 100 to No. 102 packets 910 to 912 transmitted from the transmitting-side device to the receiving-side device, the No. 101 packet 911 fails to reach (is lost). In this case, the receiving-side device adds SACK information indicative of reception of the No. 102 packet 912 to an ACK packet 913 indicating that up to the No. 100 packet has been received.

In the case of high-speed data communication, the transmitting-side device does not wait for the ACK packet 913 to arrive and successively transmits subsequent packets, that is, No. 103 and No. 104 packets 914 and 915. Since the No. 101 packet 911 is not received yet, the receiving-side device adds SACK information indicative of reception of the No. 102 through No. 104 packets to an ACK packet 916 indicating that up to the No. 100 packet has been received.

Subsequently, No. 105 and No. 106 packets 917 and 918 are similarly successively transmitted from the transmitting-side device, and the receiving-side device transmits an ACK packet 919 which is indicative of reception of packets up to the No. 100 packet and to which is added information indicating that the No. 102 to No. 106 packets have been received.

On receiving the ACK packets 913, 916 and 919, the transmitting-side device recognizes that the No. 101 packet 911 failed to reach, and thus, retransmits the No. 101 packet 920. The transmitting-side device thereafter transmits a No. 107 packet 921, whereupon the receiving-side device returns an ACK response packet 922 indicating that up to the No. 107 packet has been received. Subsequently, No. 108 and No. 109 packets 923 and 924 are successively transmitted from the transmitting-side device.

In this manner, even if a packet is lost, only the lost packet can be retransmitted, whereby retransmission of unnecessary packets is prevented.

However, SACK permits only a maximum of four pieces of information to be carried by one packet, and accordingly, if packets are frequently lost at random due to congestion, it is not possible to add information indicative of all of the randomly received packets to an acknowledgment packet. Moreover, SACK cannot be used as a substitute for ACK (SACK is defined such that it is in no way equivalent to the acknowledgment). Accordingly, even if reception of a certain packet by the receiving-side device is acknowledged by SACK, the packet needs to be retransmitted unless an ACK packet acknowledging reception of that packet is received.

Thus, in the situation where data packets are frequently lost, not only retransmission of lost packets but redundant retransmission of already delivered packets occur despite the use of SACK.

### SUMMARY OF THE INVENTION

The present invention was created in view of the above circumstances, and an object thereof is to provide congestion control network relay device and method which can prevent redundant retransmission of packets already delivered to a receiving-side device.

To achieve the object, there is provided a congestion control network relay device for relaying data between a plurality of transmission paths. The congestion control network relay device comprises an acknowledgment packet detector for detecting, from among packets transferred via the transmission paths, an acknowledgment packet by means of which a receiving-side device returns an identification number of a data packet received thereby to a transmitting-side device, a receive packet manager for registering, in an acknowledgment information memory, the identification number of the data packet whose reception has been acknowledged by the receiving-side device, based on the acknowledgment packet detected by the acknowledgment packet detector, a packet reception determination unit for comparing an identification number of a data packet transmitted from the transmitting-side device with the identification number stored in the acknowledgment information memory, to determine whether or not the data packet transmitted from the transmitting-side device has already been received by the receiving-side device, and a packet transfer unit for discarding the data packet transmitted from the transmitting-side device if it is judged by the packet reception determination unit that the data packet has already been received by the receiving-side device, and transferring the data packet transmitted from the transmitting-side device to the receiving-side device if it is judged by the packet reception determination unit that the data packet has not yet been received by the receiving-side device.

Also, to achieve the above object, there is provided a congestion control network relay method for relaying data between a plurality of transmission paths. The congestion control network relay method comprises the step of causing an acknowledgment packet detector to detect, from among packets transferred via the transmission paths, an acknowledgment packet by means of which a receiving-side device returns an identification number of a data packet received thereby to a transmitting-side device, the step of causing a receive packet manager to register, in an acknowledgment information memory, the identification number of the data packet whose reception has been acknowledged by the receiving-side device, based on the acknowledgment packet detected by the acknowledgment packet detector, the step of causing a packet reception determination unit to compare an identification number of a data packet transmitted from the transmitting-side device with the identification number stored in the acknowledgment information memory, and thereby determine whether or not the data packet transmitted from the transmitting-side device has already been received by the receiving-side device, and the step of causing a packet transfer unit to discard the data packet transmitted from the transmitting-side device if it is judged by the packet reception determination unit that the data packet has already been received by the receiving-side device, and to transfer the data packet transmitted from the transmitting-side device to the receiving-side device if it is judged by the packet reception determination unit that the data packet has not yet been received by the receiving-side device.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 schematically illustrates an embodiment of the present invention.

FIG. 2 exemplifies a system configuration of the embodiment.

FIG. 3 exemplifies a hardware configuration of a congestion control network relay device according to the embodiment.

FIG. 4 is a block diagram illustrating functions of the congestion control network relay device.

FIG. 5 exemplifies a data structure of a session management table.

FIG. 6 exemplifies a data structure of a data management table.

FIG. 7 illustrates a redundant retransmission control process.

FIG. 8 is a flowchart showing a procedure for the redundant retransmission control process.

FIG. 9 illustrates a responsive retransmission process using a data cache.

FIG. 10 is a flowchart showing a procedure for a packet retransmission process.

FIG. 11 illustrates a partial data caching process.

FIG. 12 is a flowchart showing a procedure for a transmission quality determination process.

FIG. 13 is a flowchart showing a procedure for the partial data caching process.

FIG. 14 illustrates an acknowledgment packet conversion process.

FIG. 15 is a flowchart showing a procedure for the acknowledgment packet conversion process.

FIG. 16 exemplifies a combination of the acknowledgment packet conversion process and the partial data caching process.

FIG. 17 is a graph showing an effective communication rate of a link in an overloaded state.

FIG. 18 shows a second example of installation of the congestion control network relay device.

FIG. 19 shows a third example of installation of the congestion control network relay device.

FIG. 20 shows a fourth example of installation of the congestion control network relay device.

FIG. 21 shows a fifth example of installation of the congestion control network relay device.

FIG. 22 shows a sixth example of installation of the congestion control network relay device.

FIG. 23 exemplifies conventional congestion control.

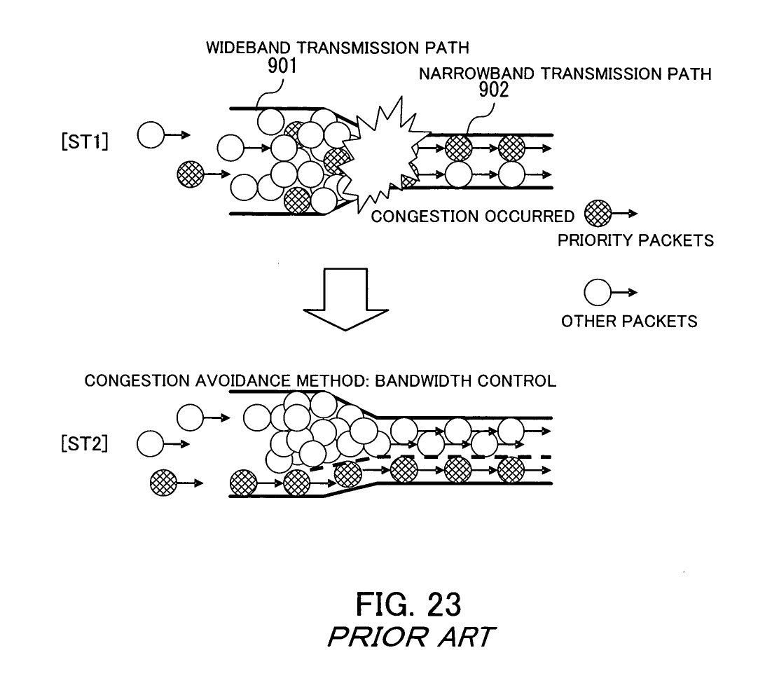

FIG. 24 illustrates a communication state during congestion control.

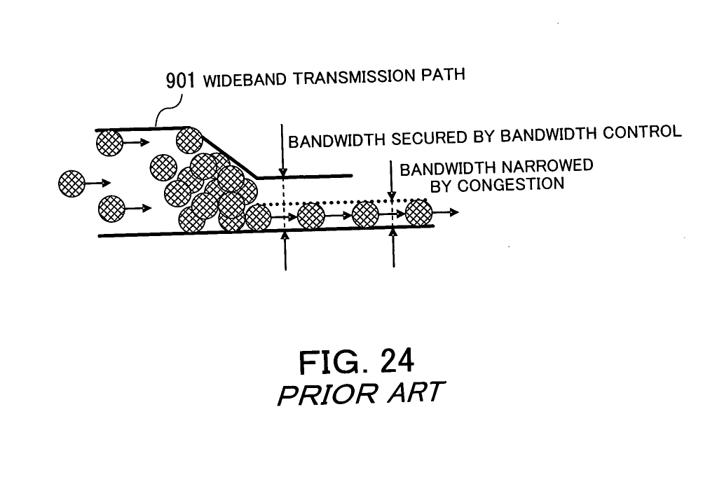

FIG. 25 exemplifies data transfer using SACK.

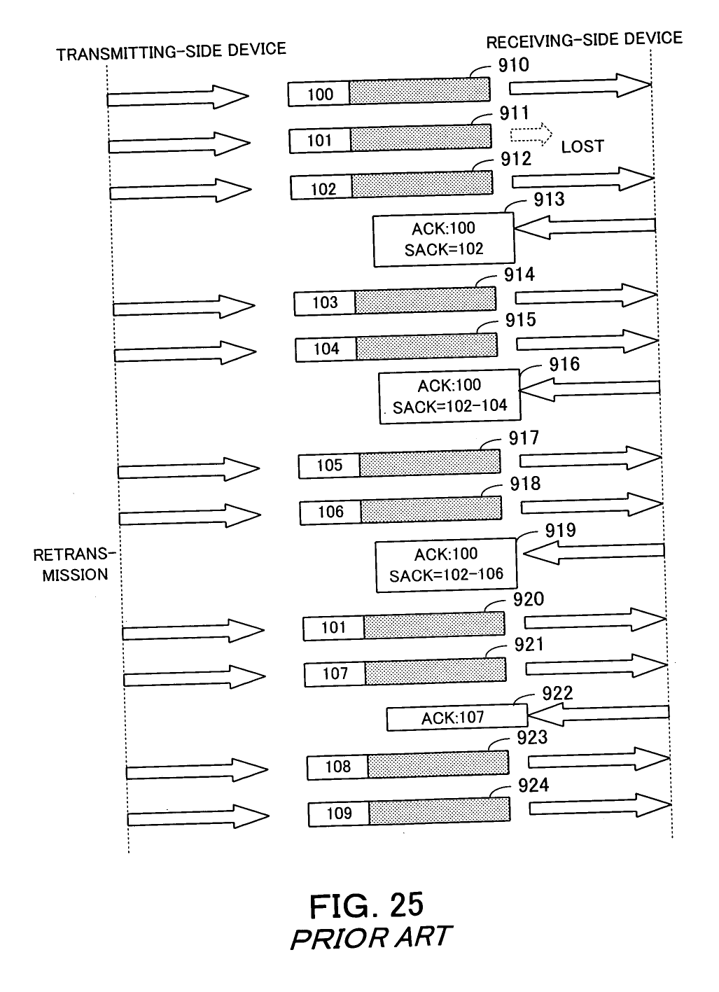

### DESCRIPTION OF THE PREFERRED EMBODIMENTS

Preferred embodiments of the present invention will be described below with reference to the accompanying drawings.

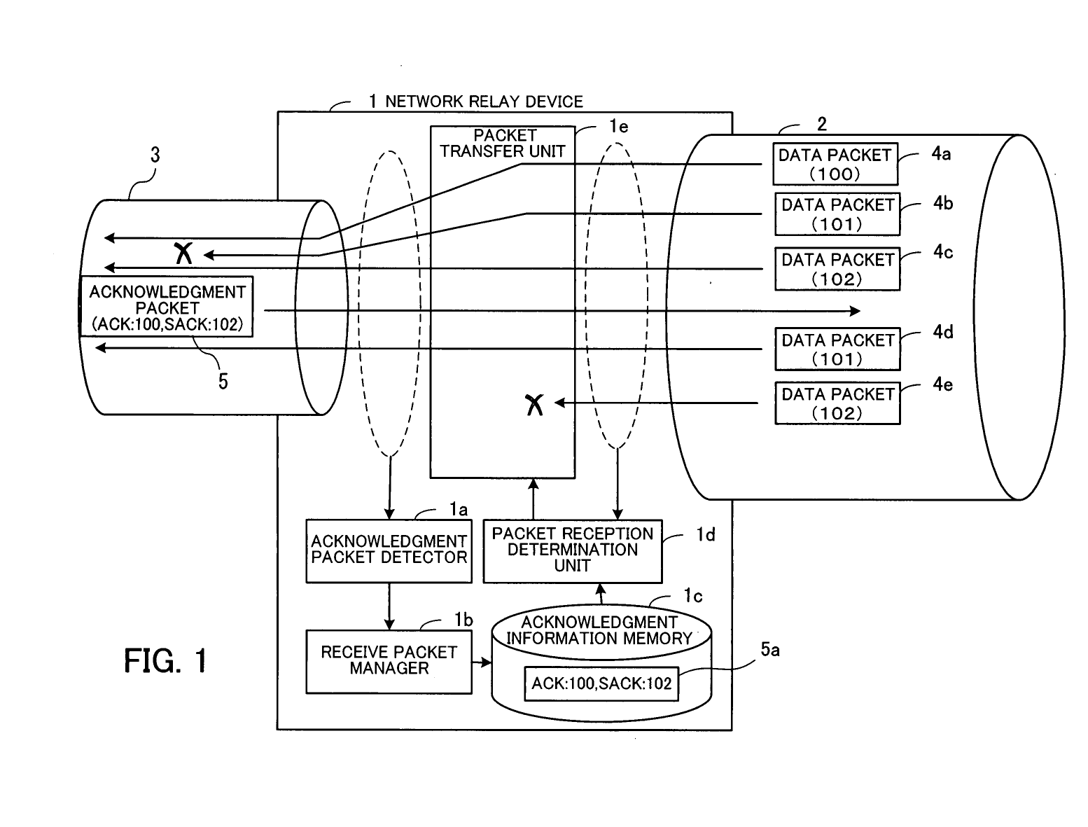

FIG. 1 schematically illustrates an embodiment of the present invention. A congestion control network relay device 1 is adapted to relay data between transmission paths 2 and 3. In the example shown in FIG. 1, it is assumed that the transmission speed of the transmission path 3 is lower than that of the transmission path 2, and also that the network relay device 1 is connected to a transmitting-side device via the transmission path 2, as well as to a receiving-side device via the transmission path 3. The congestion control network relay device 1 comprises an acknowledgment packet detector 1a, a receive packet manager 1b, an acknowledgment information memory 1c, a packet reception determination unit 1d, and a packet transfer unit 1e.

The acknowledgment packet detector 1a detects, from among packets transferred through the transmission paths 2 and 3, an acknowledgment packet 5 by means of which the receiving-side device returns the identification numbers of data packets 4a and 4b received thereby to the transmitting-side device. In the example of FIG. 1, the data packets 4a and 4c, among the data packets 4a, 4b and 4c transmitted from the transmitting-side device, are received by the receiving-side device, for example. In this case, the receiving-side device transmits the acknowledgment packet 5 which includes information (ACK: 100) acknowledging reception of packets up to the data packet 4a with the identification number (100) and information (SACK: 102) indicating reception of the data packet 4c with the identification number (102).

The receive packet manager 1b registers, in the acknowledgment information memory 1c, the identification numbers of the data packets of which the reception has been acknowledged by the receiving-side device, on the basis of the acknowledgment packet 5 detected by the acknowledgment packet detector 1a. In the example of FIG. 1, the receive packet manager 1b stores, in the acknowledgment information memory 1c, the information (ACK: 100) acknowledging reception of packets up to the data packet 4a with the identification number (100) and the information (SACK: 102) indicating reception of the data packet 4c with the identification number (102), as acknowledgment information 5a.

The packet reception determination unit 1d compares the identification number of a data packet transmitted from the transmitting-side device with the identification numbers stored in the acknowledgment information memory 1c. Then, the packet reception determination unit 1d determines whether or not data packets 4d and 4e transmitted from the transmitting-side device have already been received by the receiving-side device. In the example of FIG. 1, the data packets 4d and 4e have identification numbers “101” and “102”, respectively. In this case, the packet reception determination unit 1d judges that the data packet 4e has already been received by the receiving-side device while the data packet 4d has not been received yet.

It is judged by the packet reception determination unit 1d that the data packet 4e transmitted from the transmitting-side device has already been received by the receiving-side device, and in this case, the packet transfer unit 1e discards the packet. Also, it is judged by the packet reception determination unit 1d that the data packet 4d transmitted from the transmitting-side device has not yet been received by the receiving-side device, in which case the packet transfer unit 1e transfers the packet to the receiving-side device.

In the congestion control network relay device 1 configured as above, when the data packets 4a, 4b and 4c transmitted from the transmitting-side device are input via the transmission path 2 (assuming that the packets are not retransmission packets), for example, the packet transfer unit 1e transfers the data packets 4a, 4b and 4c to the transmission path 3. If, at this time, congestion occurs on the transmission path 3 and the data packet 4b is lost as a result, the receiving-side device transmits the acknowledgment packet 5 indicating reception of the data packets 4a and 4c.

The acknowledgment packet 5 is detected by the acknowledgment packet detector 1a, and the acknowledgment information 5a is stored in the acknowledgment information memory 1c by the receive packet manager 1b. As is the case with ordinary communications, the acknowledgment packet 5 is transferred to the transmitting-side device by the packet transfer unit 1e.

Subsequently, the transmitting-side device detects the loss of the data packet 4b and retransmits the data packet 4b and the following packets, that is, the data packets 4d and 4e. In the congestion control network relay device 1 input with the retransmitted data packets 4d and 4e, the packet reception determination unit 1d judges that the data packet 4d has not yet been received by the receiving-side device while the data packet 4e has already been received. Accordingly, the packet transfer unit 1e transfers the data packet 4d to the receiving-side device and discards the data packet 4e.

It is therefore possible to prevent packets already delivered to the receiving-side device from being redundantly retransmitted to the transmission path connected to the receiving-side device in cases where congestion has occurred on the transmission path. Consequently, communication efficiency during congestion can be improved. Namely, it is possible to restrain congestion and restrict the extent of congestion, thereby suppressing deterioration in communication quality due to congestion and enabling effective use of network resources.

The function illustrated in FIG. 1 is applicable to the whole field of information communications via networks. For example, the function shown in FIG. 1 can be applied to TCP/IP communications. TCP/IP technologies are currently improved to an extent such that the capabilities thereof can be used effectively in high-speed, wideband network environments such as broadband environments. However, networks often include narrowband transmission paths such as radio channels. For example, some wired networks are connected with a wireless LAN (Local Area Network).

In wideband environments, networks are tuned mainly with the aim of transmitting data packets as continuously as possible. In many cases, therefore, on detection of occurrence of congestion, the transmitting side transmits not only a packet lost due to the congestion but also packets following the lost packet. If packets are retransmitted as a result of congestion, however, the congestion worsens, eventually hindering effective use of narrowband transmission paths. By applying the congestion control technique of the embodiment to the junction between a large-capacity, high-speed path and a low-speed path, it is possible to restrain congestion and restrict the extent of congestion.

Details of the embodiment will be now described.

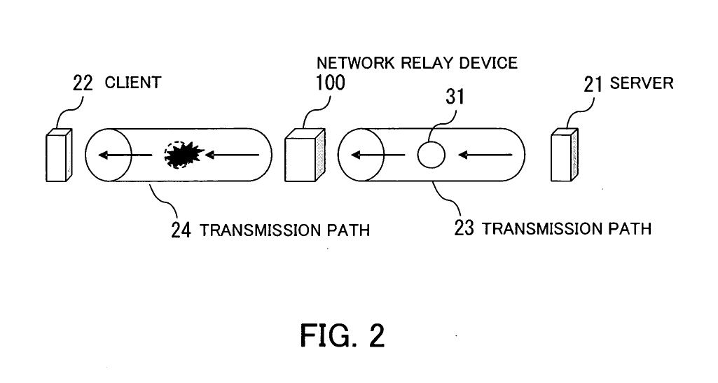

FIG. 2 shows an exemplary system configuration of the embodiment. A congestion control network relay device 100 is connected to a server 21 and a client 22 via transmission paths 23 and 24, respectively. A packet 31 transmitted from the server 21 is sent to the network relay device 100 through the transmission path 23. The packet 31 is then relayed by the network relay device 100 and sent to the client 22 through the transmission path 24.

The transmission path 24 includes therein a transmission path having a data transmission speed lower than that of the transmission path 23. For example, the transmission path 23 constitutes a high-speed LAN, whereas the internal path of the transmission path 24 constitutes a WAN (Wide Area Network) whose transmission speed is lower than the LAN.

In such networks, it is possible that packets 31 transmitted from the server 21 through the transmission path 23 cause congestion on the transmission path 24. The congestion control network relay device 100 is arranged at the entry point (packet transmission side) of the transmission path on which packets may possibly be lost due to congestion.

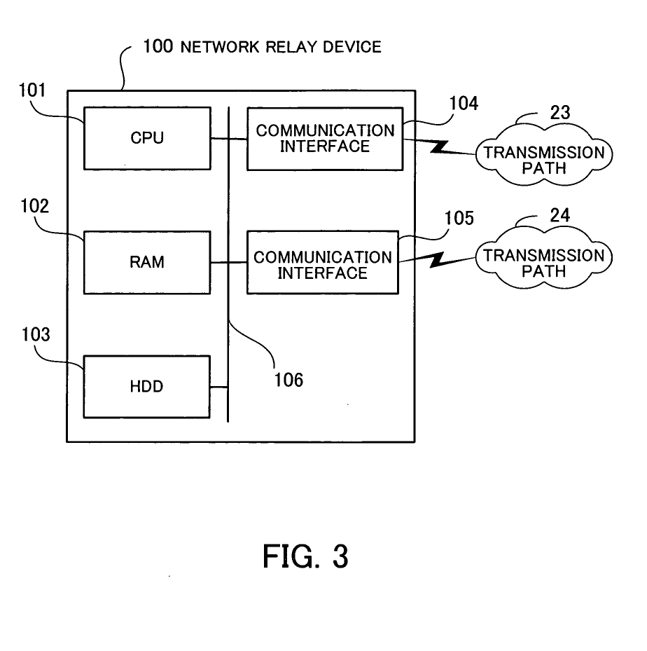

FIG. 3 shows an exemplary hardware configuration of the congestion control network relay device of the embodiment. The congestion control network relay device 100 operates under the control of a CPU (Central Processing Unit) 101. The CPU 101 is connected, via a bus 106, with a RAM (Random Access Memory) 102, a hard disk drive (HDD) 103, and communication interfaces 104 and 105.

The RAM 102 temporarily stores at least part of OS (Operating System) and application programs executed by the CPU 101. Also, the RAM 102 stores various other data necessary for the processing by the CPU 101. The HDD 103 stores the OS and application programs.

The communication interface 104 is connected to the transmission path 23 and permits transmission/reception of data to/from the server 21 via the transmission path 23.

The communication interface 105 is connected to the transmission path 24 and permits transmission/reception of data to/from the client 22 via the transmission path 24.

The processing function of the embodiment is accomplished by the hardware configuration described above.

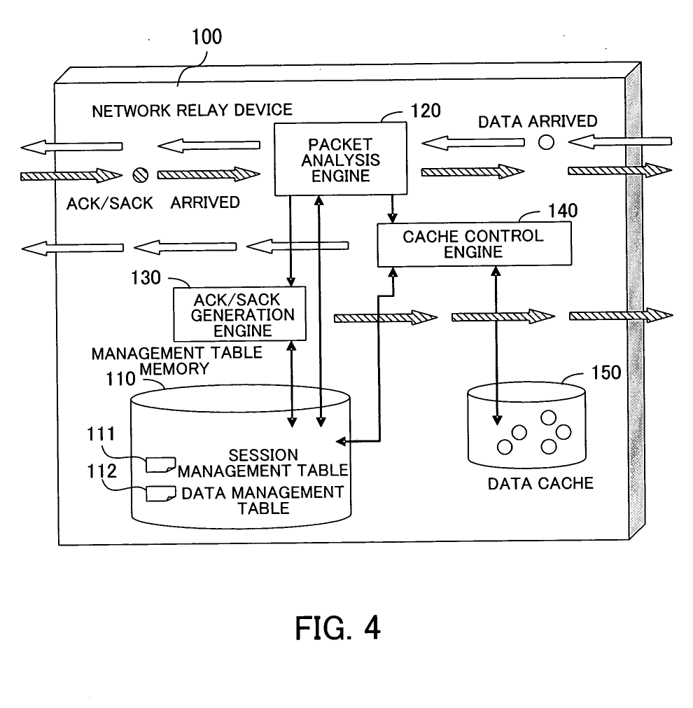

FIG. 4 is a block diagram illustrating functions of the congestion control network relay device. The congestion control network relay device 100 includes a management table memory 110, a packet analysis engine 120, an ACK/SACK generation engine 130, a cache control engine 140, and a data cache 150.

The management table memory 110 stores a session management table 111 and a data management table 112. The session management table 111 has registered therein data for managing a session established between the server 21 and the client 22. In the data management table 112 is registered data for managing data exchanged between the server 21 and the client 22.

The packet analysis engine 120 analyzes the contents of relayed packets. When a session-related packet (SYN, FIN, RSET, etc.) is received, the packet analysis engine 120 carries out addition, deletion or modification of data with respect to the session management table 111.

Also, when a data packet is received, the packet analysis engine 120 looks up the session management table 111 and the data management table 112 to perform the process described below. On reception of a data packet, first, the packet analysis engine 120 checks the data packet and performs processes such as determination as to whether or not the packet may be discarded, determination as to whether or not the packet needs to be cached, and updating of the session table. Then, in accordance with the check results, the packet analysis engine 120 carries out processes such as forwarding of the packet, storage of the packet in the cache, and output of an instruction to the cache control engine 140 to read out a data packet from the cache.

Further, when an ACK/SACK packet is received, the packet analysis engine 120 checks the received packet against the data in the management table memory 110 to determine whether or not ACK/SACK conversion is required. If the conversion is necessary, the packet analysis engine 120 requests the ACK/SACK generation engine 130 to perform the conversion.

The ACK/SACK generation engine 130 carries out conversion from ACK to SACK and vice versa. Also, the ACK/SACK generation engine 130 performs processes such as output of a retransmission request.

The cache control engine 140 carries out cache-related processes for data packets. Specifically, the processes performed by the cache control engine 140 include saving/fetching data in/from the data cache 150, garbage collection, etc.

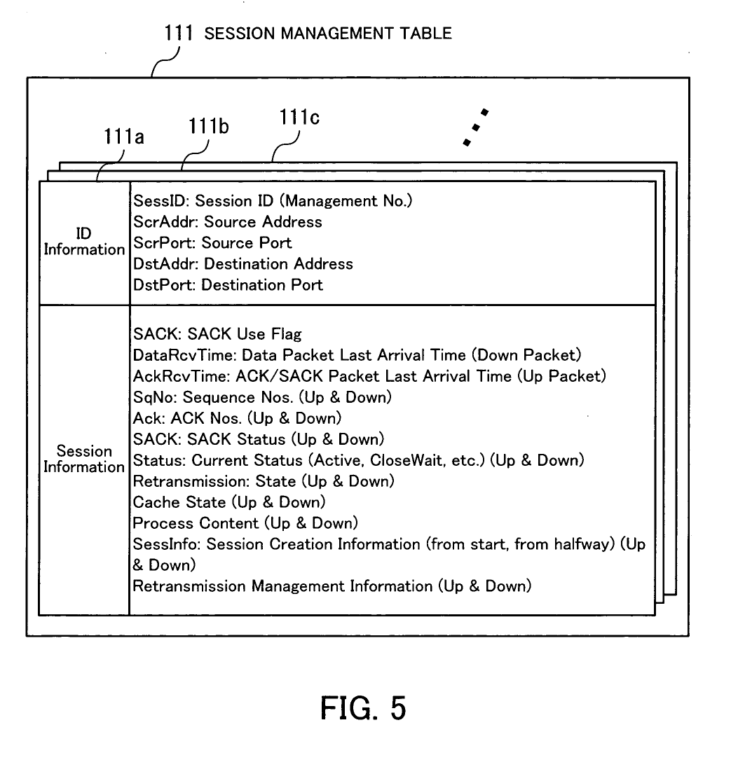

FIG. 5 shows an exemplary data structure of the session management table. In the session management table 111 are registered multiple sets of session management information 111a, 111b, 111c, . . . associated with respective sessions. Each of the session management information 111a, 111b, 111c, . . . is divided roughly into session identification (ID) information and session information.

The session identification information includes “Session ID (SessID)”, “Source Address (ScrAddr)”, “Source Port (ScrPort)”, “Destination Address (DstAddr)”, and “Destination Port (DstPort)”.

“Session ID” is a session management number. “Source Address” is the IP address of a transmitting-side device (e.g., server 21) which is transmitting data in the session concerned. “Source Port” indicates the port number of an application associated with the session in the transmitting-side device. “Destination Address” is the IP address of a destination device (e.g., client 22) which is receiving data in the session concerned. “Destination Port” denotes the port number of an application associated with the session in the destination device.

The session information includes “SACK Use Flag (SACK)”, “Data Packet Last Arrival Time (DataRcvTime)”, “ACK/SACK Packet Last Arrival Time (AckRcvTime)”, “Sequence Nos. (SqNo)”, “ACK Nos. (ACK)”, “SACK Status (SACK)”, “Current Status (Active, CloseWait, etc.) (Status)”, “Retransmission State”, “Cache State”, “Process Content”, “Session Creation Information (SessInfo)”, and “Retransmission Management Information”.

“Data Packet Last Arrival Time” indicates the time at which a down data packet (e.g., data packet from the server 21 to the client 22) arrived last.

“ACK/SACK Packet Last Arrival Time” indicates the time at which an up ACK/SACK packet arrived last.

“Sequence Nos.” indicates the sequence numbers of up and down packets.

“ACK Nos.” indicates ACK numbers (sequence numbers acknowledged by ACK) with respect to up and down packets.

“SACK Status” indicates the sequence numbers of up and down packets, notified by means of SACK.

“Current Status” indicates status information indicating the status of communication in up and down directions. As the status information, information such as “Active” (indicating that communication is under way) or “CloseWait” (indicating a wait state waiting for a response from the other side of communication at termination of communication) is recorded, for example.

“Retransmission State” indicates information indicating the status of packet retransmission in up and down directions. For example, information indicating whether a packet has been retransmitted or not is stored as the retransmission state. Also, information indicating the total number of data packets transmitted per unit time and the number of retransmitted data packets may be stored as the retransmission state.

“Cache State” shows information indicating, with respect to up and down packets, whether the packet should be cached or not.

In “Process Content”, the contents of processes to be performed on transferred packets are defined with respect to up and down packets. For example, the condition for starting caching, the condition for discarding cached packets, etc. are defined.

“Session Creation Information” is information indicating, with respect to up and down directions, whether the session has been managed from the start or from halfway. In principle, a session is managed from the start by the congestion control network relay device 100; however, if a session is already established when the network relay device 100 is started, the session is managed from halfway.

“Retransmission Management Information” is information indicating, with respect to up and down packets, whether the packet should be retransmitted or not.

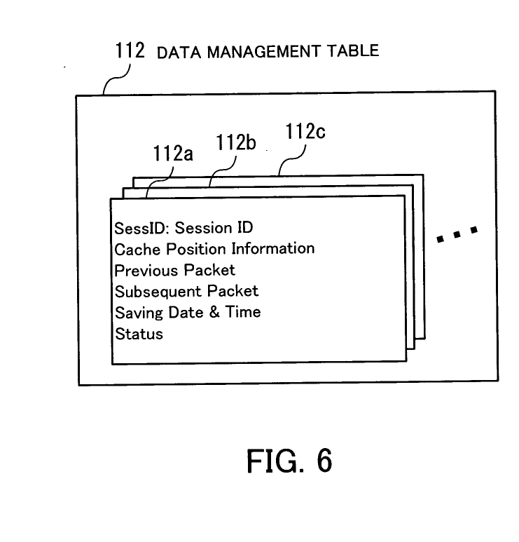

FIG. 6 shows an exemplary data structure of the data management table. The data management table 112 stores multiple sets of data management information 112a, 112b, 112c, . . . for managing individual relayed data. Specifically, each of the data management information 112a, 112b, 112c, . . . stores, with respect to the corresponding data, information including “Session ID (SessID)”, “Cash Position Information”, “Previous Packet”, “Subsequent Packet”, “Saving Date & Time”, and “Status”.

“Session ID” is the session management number, and “Cache Position Information” is information specifying the storage location of the managed data in the data cache 150. “Previous Packet” indicates information about the packet transferred in the same session before the managed data, and “Subsequent Packet” indicates information about the packet which is to be transferred in the same session subsequently to the managed data. “Saving Date & Time” indicates information about the date and time when the managed data was stored in the data cache 150, and “Status” indicates information about the status at the time the data was stored.

The following explains in detail a congestion control process performed by the congestion control network relay device 100 configured as described above. The congestion control process of this embodiment includes a redundant retransmission control process, a responsive retransmission process using the data cache, a partial data caching process, and an acknowledgment packet-to-retransmission request conversion process.

First, the redundant retransmission control process will be described.

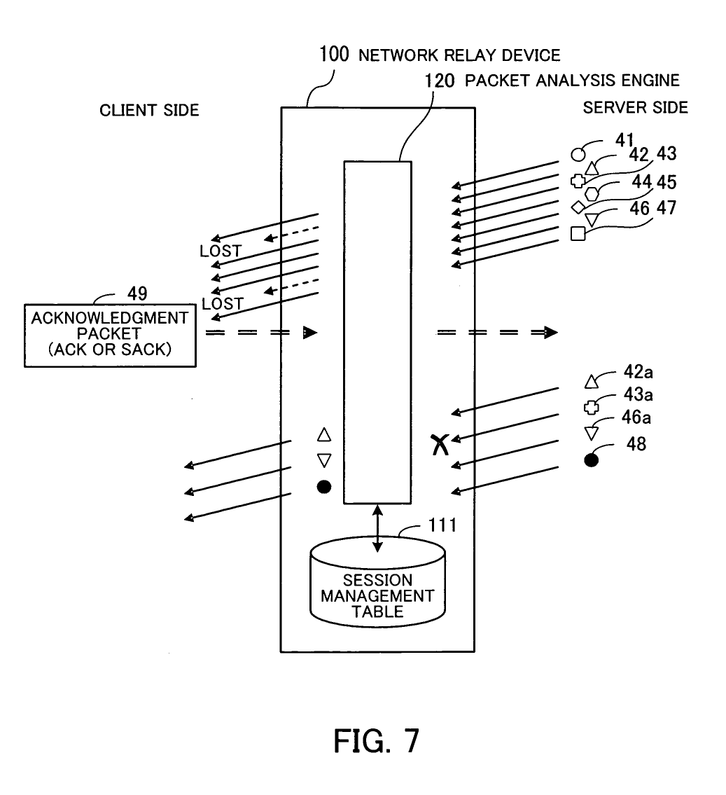

FIG. 7 illustrates the redundant retransmission control process. In the example of FIG. 7, it is assumed that data packets 41 to 47 transmitted from the server 21 are relayed by the congestion control network relay device 100 and sent to the client 22.

The packet analysis engine 120 stores the acknowledgment number of an acknowledgment packet 49 (ACK or SACK) traveling on the traffic as well as the range of received packets, and discards redundant retransmission packets. Specifically, the packet analysis engine 120 reads out information about the acknowledgment number and the reception range, described in the acknowledgment packet 49 (ACK or SACK) transmitted in response to the packets 41 to 47, and stores the information in the session management table 111 as the session management information. Simultaneously, the packet analysis engine 120 transfers the acknowledgment packet 49 received from the client 22 to the server 21.

On detection of congestion, the server 21 retransmits packets. In the example of FIG. 7, retransmission packets 42a, 43a and 46a of the packets 42, 43 and 46, respectively, are transmitted from the server 21. Generally, when retransmitting packets, the server 21 decreases the amount of data transmitted per unit time, to prevent congestion from occurring again.

The packet analysis engine 120 detects redundantly transmitted data packets on the basis of the session management information stored in the session management table 111. Such redundantly transmitted data packets are discarded by the packet analysis engine 120. In the example of FIG. 7, it is assumed that the reception of the packet 43 by the client 22 has been acknowledged by the acknowledgment packet 49. In this case, the packet analysis engine 120 discards the retransmission packet 43a of the packet 43 and transfers the other retransmission packets 42a and 46a to the transmission path 24 connected to the client 22.

When a subsequent packet 48 is received thereafter from the server 21, the packet analysis engine 120 transfers the packet 48 to the transmission path 24 connected to the client 22.

The following describes details of a procedure for the redundant retransmission control process executed by the packet analysis engine 120.

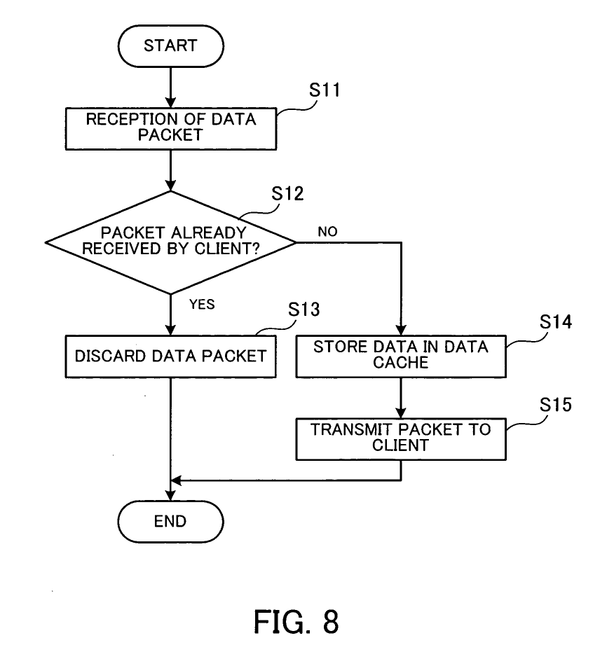

FIG. 8 is a flowchart showing the procedure for the redundant retransmission control process. In the following, the process shown in FIG. 8 will be explained in order of step number.

(STEP S11) The packet analysis engine 120 receives a data packet from the server 21 via the transmission path 23.

(STEP S12) The packet analysis engine 120 determines whether or not the packet has already been received by the client 22. Specifically, the packet analysis engine 120 looks up the session management table 111, extracts information about the ACK number and the SACK status from the session information for the session corresponding to the received data packet, and detects the sequence numbers of packets already received by the client 22. Then, the packet analysis engine 120 determines whether or not a packet with a sequence number identical with that of the received data packet has already been received by the client 22.

If such a packet has already been received by the client 22, the process proceeds to Step S13; if not, the process proceeds to Step S14.

(STEP S13) Since the data packet has already been received by the client 22, the packet analysis engine 120 discards the data packet, followed by termination of the process.

(STEP S14) Since the data packet has not yet been received by the client 22, the packet analysis engine 120 stores, in the data cache 150, data contained in the packet.

(STEP S15) The packet analysis engine 120 forwards the packet to the client 22, whereupon the process is ended.

In this manner, when an acknowledgment packet (ACK or SACK) is received from the client 22, the packet analysis engine 120 records, in the session management table 111, the sequence number of the received packet indicated by ACK as well as the range of sequence numbers indicated by SACK. Then, using the session management table 111, the packet analysis engine 120 manages the sequence numbers of packets received by the client 22 so that the packets already received by the client 22 (the packets of which the acknowledgment has already been returned) may be discarded by the congestion control network relay device 100.

The packet analysis engine 120 is capable of requesting the ACK/SACK generation engine 130 to transmit an ACK or SACK acknowledgment packet, in place of the client 22. The acknowledgment packet from the client 22 is received by the packet analysis engine 120 but may possibly be lost before reaching the server 21. Thus, in cases where a packet whose reception has been acknowledged by an acknowledgment packet from the client 22 is retransmitted from the server 21, the packet analysis engine 120 requests the ACK/SACK generation engine 130 to transmit ACK or SACK acknowledging reception of the packet. In response to the request, the ACK/SACK generation engine 130 generates an ACK or SACK acknowledgment packet and transmits the generated packet to the server 21.

The ACK/SACK generation engine 130 can determine whether or not SACK can be used in a certain session, by looking up the corresponding SACK use flag in the session information of the session management table 111. If SACK cannot be used, the ACK/SACK generation engine 130 generates an ACK acknowledgment packet.

If SACK can be used, the ACK/SACK generation engine 130 determines whether to use SACK. SACK is used in the case where a packet following the lost packet has been received by the client 22. When SACK is to be used, the ACK/SACK generation engine 130 generates an ACK acknowledgment packet containing SACK information. On the other hand, when SACK need not be used, an ACK acknowledgment packet is generated.

The packet analysis engine 120 does not request the ACK/SACK generation engine 130 to transmit ACK or SACK for packets other than those whose reception has been acknowledged by ACK or SACK from the receiving side.

The data caching process executed by the congestion control network relay device 100 will be now described. The network relay device 100 is capable of performing responsive retransmission, in place of the transmitting side, by caching packets passing therethrough.

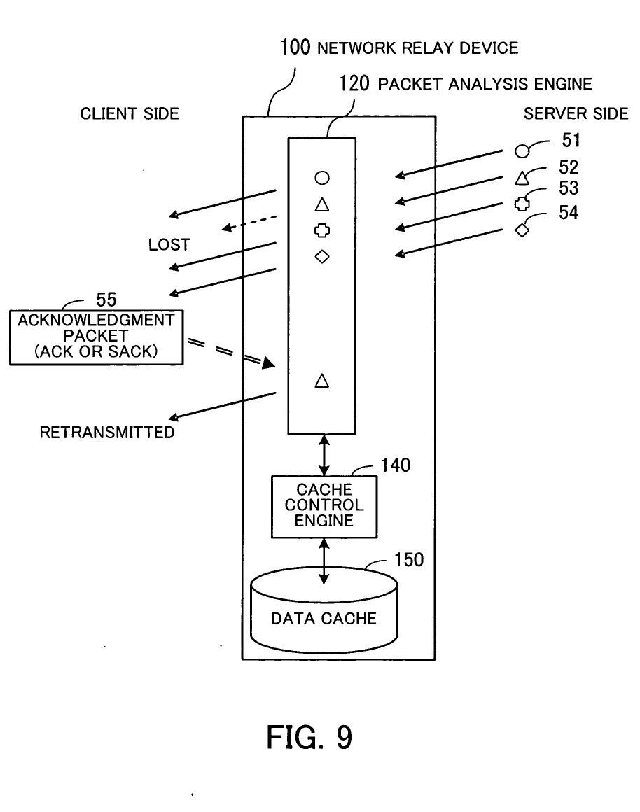

FIG. 9 illustrates the responsive retransmission process using the data cache. When packets 51 to 54 are received from the server 21, the packet analysis engine 120 in the congestion control network relay device 100 transfers the packets 51 to 54 to the client 22. At this time, the packet analysis engine 120 looks up the session management table 111 to determine whether or not each of the packets has already been received by the client. If a packet has already been received by the client, the packet analysis engine 120 discards the received packet. On the other hand, if a packet has not yet been received by the client, the packet analysis engine 120 stores, in the data cache 150, data contained in the packet via the cache control engine 140 and also forwards the received packet to the client 22.

It is assumed here that the packet 52 is lost. In this case, the client 22 transmits an acknowledgment packet 55 which includes ACK indicating reception of packets up to the packet 51 and to which is also added SACK indicating reception of the packets 53 and 54.

On receiving the acknowledgment packet 55, the packet analysis engine 120 acquires the data of the packet 52 from the data cache 150 via the cache control engine 140. Then, the packet analysis engine 120 transmits a retransmission packet containing the acquired data to the client 22.

In the case where the packet 52 is retransmitted thereafter from the server 21, the packet analysis engine 120 discards the retransmission packet.

The packet analysis engine 120 does not transmit to the server 21 ACK or SACK for packets other than those of which the reception has been acknowledged by ACK or SACK from the client 22. Specifically, even after a packet is retransmitted from the packet analysis engine 120 to the client 22, the packet analysis engine 120 does not output an acknowledgment packet for the retransmitted packet to the server 21 until an acknowledgment packet responsive to the retransmitted packet is received from the client 22.

The process performed by the congestion control network relay device 100 when a data packet is received from the server 21 has already been explained with reference to FIG. 8. The following describes a procedure for a packet retransmission process executed by the packet analysis engine 120 when a SACK acknowledgment packet is received from the client 22.

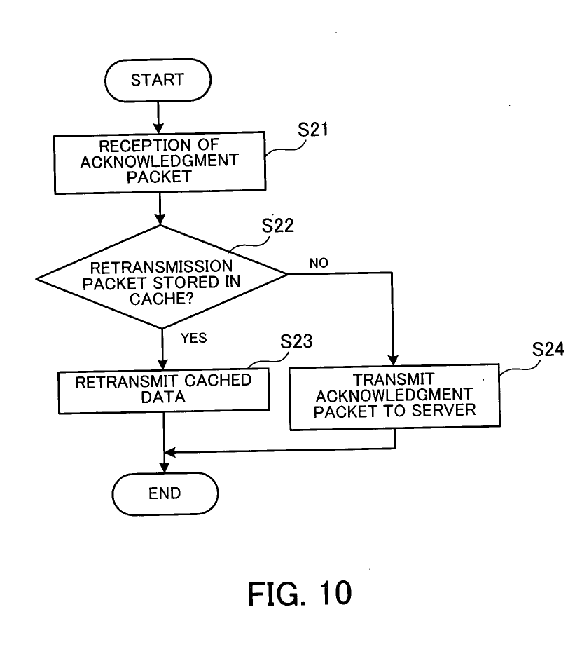

FIG. 10 is a flowchart showing the procedure for the packet retransmission process. In the following, the process shown in FIG. 10 will be explained in order of step number.

(STEP S21) The packet analysis engine 120 receives an ACK or SACK acknowledgment packet from the client 22.

(STEP S22) The packet analysis engine 120 determines whether or not a retransmission packet to be retransmitted is stored in the data cache 150. Specifically, the packet analysis engine 120 looks up the session management table 111 and identifies, as the retransmission packet, a packet which has already been transmitted to the client 22 but with respect to which no acknowledgment packet has been received yet. Then, the packet analysis engine 120 inquires of the cache control engine 140 whether the retransmission packet is stored in the data cache 150. If the data of the retransmission packet is stored in the data cache 150, the cache control engine 140 transfers the data to the packet analysis engine 120. If the data of the retransmission packet is not stored in the data cache 150, the cache control engine 140 notifies the packet analysis engine 120 that the data is not stored.

If the data to be retransmitted is stored in the data cache 150, the process proceeds to Step S23; if not, the process proceeds to Step S24.

(STEP S23) The packet analysis engine 120 generates a retransmission packet containing the data received from the cache control engine 140 and transmits the generated retransmission packet to the client 22, followed by termination of the process.

(STEP S24) The packet analysis engine 120 transmits the acknowledgment packet received in Step S21 to the server 21, whereupon the process is ended.

In this manner, the congestion control network relay device 100 is capable of retransmitting packets in place of the server 21.

In the example shown in FIGS. 9 and 10, the data caching is carried out at all times, but the caching may be switched on and off as needed. For example, the congestion control network relay device 100 may be adapted to determine the transmission path quality on the basis of the SACK status and to start the data caching if the packet loss becomes noticeable.

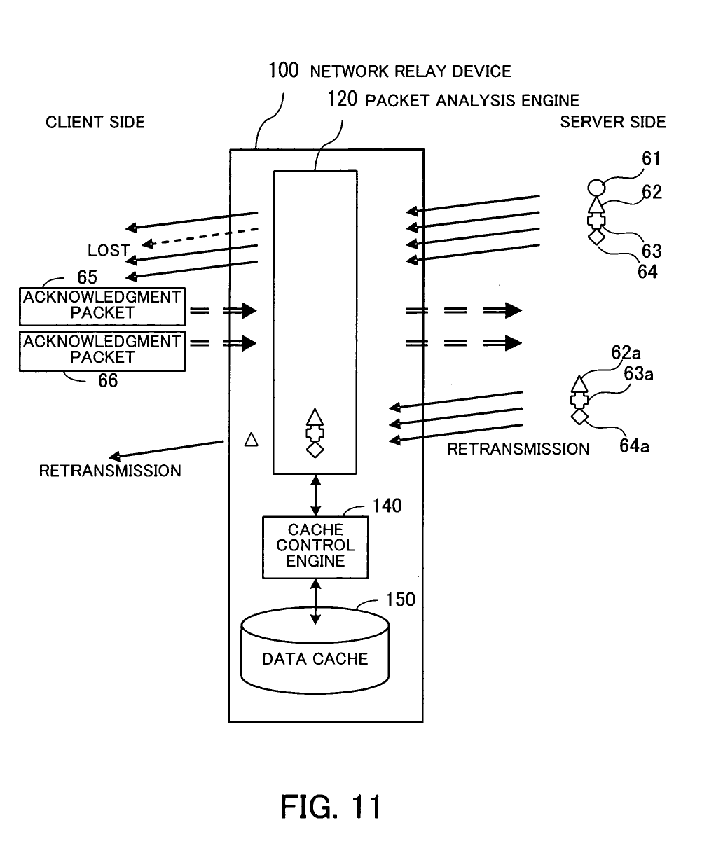

FIG. 11 illustrates the partial data caching process. When packets 61 to 64 are received from the server 21, the packet analysis engine 120 in the congestion control network relay device 100 transfers the packets 61 to 64 to the client 22.

At this time, the packet analysis engine 120 looks up the cache state in the session management table 111 to determine the need for caching. The cache state is set so that the caching may be stopped if the transmission path 24 connected to the client 22 is not congested.

In the example of FIG. 11, it is assumed that the transmission path is not congested at the time when the congestion control network relay device 100 receives the packets 61 to 64. In this case, the packets 61 to 64 are not cached. Let us suppose that due to congestion caused thereafter during the transmission of the packets 61 to 64 via the transmission path 24 connected to the client 22, the packet 62, for example, is lost.

In this case, the client 22 outputs an ACK acknowledgment packet 65 acknowledging reception of packets up to the packet 61, as well as a SACK acknowledgment packet 66 acknowledging reception of the packet 61 and the packets 63 and 64. The acknowledgment packets 65 and 66 are transferred to the server 21 by the packet analysis engine 120.

At this time, the packet analysis engine 120 analyzes the acknowledgment packets 65 and 66 and judges that congestion has occurred on the transmission path 24. On detection of the congestion, the packet analysis engine 120 accesses the session management table 111 and changes the cache state to “Start Caching”.

When retransmission packets 62a, 63a and 64a are received thereafter from the server 21, the packet analysis engine 120 forwards, to the client 22, the retransmission packet 62a corresponding to the packet 62 which failed to reach the client 22. The packet analysis engine 120 discards the other retransmission packets 63a and 64a with respect to which reception has already been acknowledged. Also, the packet analysis engine 120 stores, in the data cache 150, the data contained in the retransmission packets 62a, 63a and 64a via the cache control engine 140.

In this manner, the congestion control network relay device 100 determines the transmission path quality on the basis of the SACK status and starts the data caching if the packet loss becomes noticeable. Also, the network relay device 100 can send a retransmission request early to the server 21 and can start the data caching early.

The above process makes it unnecessary to cache data while the communication quality is of satisfactory level (while no congestion is caused).

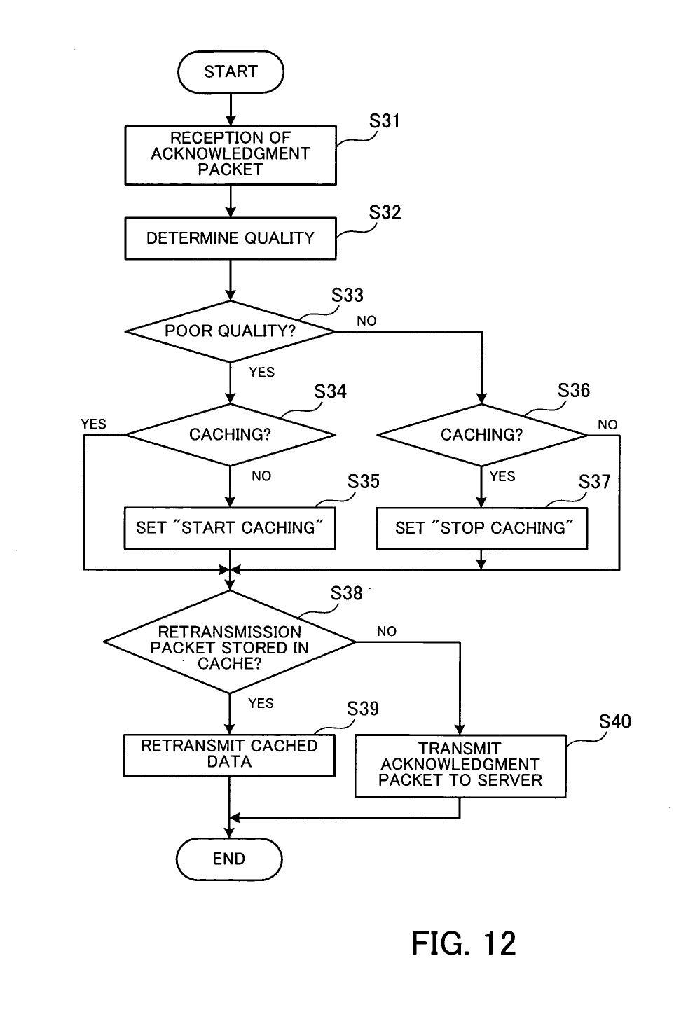

FIG. 12 is a flowchart showing a procedure for the transmission quality determination process. In the following, the process shown in FIG. 12 will be explained in order of step number.

(STEP S31) The packet analysis engine 120 receives an ACK or SACK acknowledgment packet from the client 22.

(STEP S32) The packet analysis engine 120 determines the communication quality of the transmission path 24 connected to the client 22. For example, the packet analysis engine 120 determines the communication quality by judging whether or not the frequency of occurrence of retransmission is higher than a preset threshold.

(STEP S33) If it is judged by the packet analysis engine 120 that the communication quality is poor, the process proceeds to Step S34; if it is judged that the communication quality is of satisfactory level, the process proceeds to Step S36.

(STEP S34) When the communication quality is poor, the packet analysis engine 120 determines whether or not the packets transmitted from the server 21 are being cached. If the caching is under execution, the process proceeds to Step S38; if not, the process proceeds to Step S35.

(STEP S35) The packet analysis engine 120 sets the cache state in the session management table 111 to “Start Caching”. The process then proceeds to Step S38.

(STEP S36) When the communication quality is of satisfactory level, the packet analysis engine 120 determines whether or not the packets transmitted from the server 21 are being cached. If the caching is under execution, the process proceeds to Step S37; if not, the process proceeds to Step S38.

(STEP S37) The packet analysis engine 120 sets the cache state in the session management table 111 to “Stop Caching”.

(STEP S38) The packet analysis engine 120 determines whether or not a retransmission packet to be retransmitted is stored in the data cache 150. If the retransmission packet is stored in the data cache 150, the process proceeds to Step S39; if not, the process proceeds to Step S40.

(STEP S39) The packet analysis engine 120 generates a retransmission packet containing the data received from the cache control engine 140 and transmits the generated retransmission packet to the client 22, whereupon the process ends.

(STEP S40) The packet analysis engine 120 transmits the acknowledgment packet received in Step S31 to the server 21, followed by termination of the process.

In this manner, the data caching can be switched on and off in accordance with the communication quality.

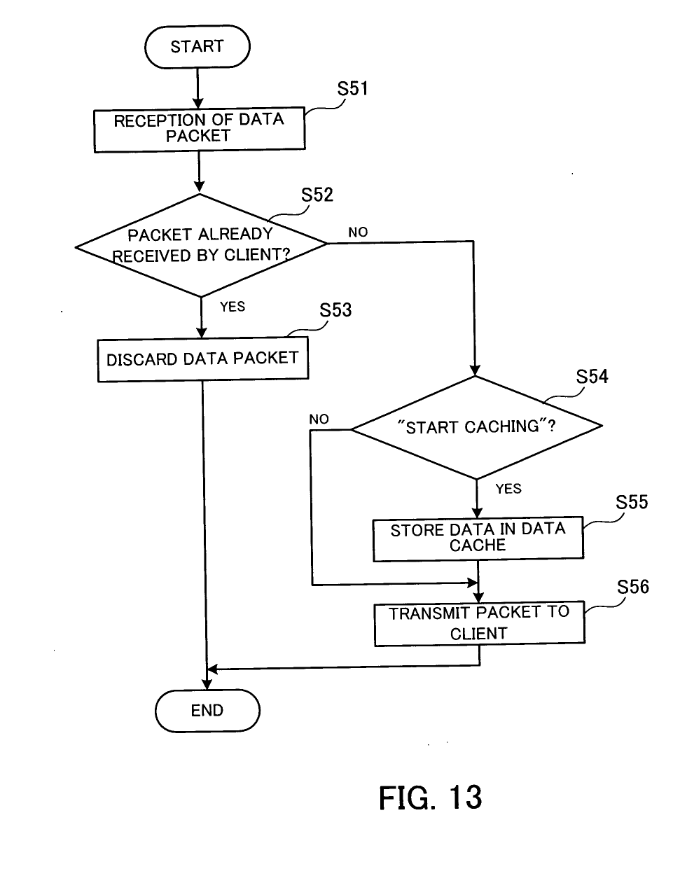

FIG. 13 is a flowchart showing a procedure for the partial data caching process. In the following, the process shown in FIG. 13 will be explained in order of step number.

(STEP S51) The packet analysis engine 120 receives a data packet from the server 21 via the transmission path 23.

(STEP S52) The packet analysis engine 120 determines whether or not the packet has already been received by the client 22. If the packet has already been received by the client 22, the process proceeds to Step S53; if the packet has not yet been received by the client 22, the process proceeds to Step S54.

(STEP S53) Since the data packet has already been received by the client 22, the packet analysis engine 120 discards the data packet, whereupon the process ends.

(STEP S54) The packet analysis engine 120 looks up the cache state in the session management table 111 to determine whether or not the cache state is set to “Start Caching”. If “Start Caching” is set, the process proceeds to Step S55; if “Stop Caching” is set, the process proceeds to Step S56.

(STEP S55) Where the data packet has not yet been received by the client 22, the packet analysis engine 120 stores, in the data cache 150, data contained in the packet.

(STEP S56) The packet analysis engine 120 forwards the data packet to the client 22, whereupon the process ends.

In this manner, the caching can be carried out only during the occurrence of congestion. Accordingly, unnecessary data can be prevented from being cached, thus permitting effective use of the recording media of the congestion control network relay device 100, such as the HDD, and also lessening the processing load on the network relay device 100.

The following describes the process of converting a SACK acknowledgment packet sent from the client 22 to a retransmission request (acknowledgment packet ×3). The congestion control network relay device 100 is capable of converting an acknowledgment packet including SACK to an ordinary ACK acknowledgment packet to request ordinary retransmission of packets from the transmitting side. For example, when it is judged in view of the communication state of the transmission path that the retransmission by means of ACK, which involves TCP congestion control, is preferable to the partial retransmission by means of SACK, the network relay device 100 converts SACK packets sent from the receiving side to ACK packets (ACK ×3) as a retransmission request and transmits the packets to the server 21.

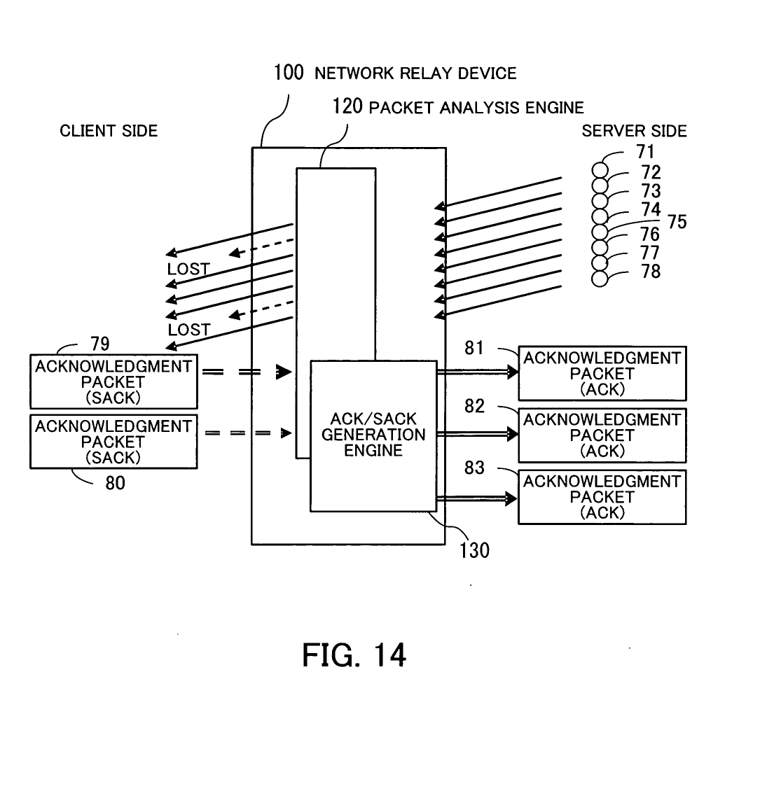

FIG. 14 illustrates the acknowledgment packet-to-retransmission request conversion process. When packets 71 to 78 are transmitted from the server 21 to the congestion control network relay device 100, the packets 71 to 78 are transferred to the client 22 via the packet analysis engine 120. If, at this time, a plurality of packets are randomly lost, the client 22 outputs a plurality of acknowledgment packets 79 and 80 including SACK information.

The packet analysis engine 120 analyzes the acknowledgment packets 79 and 80 and determines the communication state of the transmission path 24 connected to the client 22. If it is judged that numerous packets have been lost on the transmission path 24 and thus that the retransmission by means of ACK, which involves TCP congestion control, is preferable to the partial retransmission by means of SACK, the packet analysis engine 120 requests the ACK/SACK generation engine 130 to transmit a retransmission request. In response to the request, the ACK/SACK generation engine 130 successively transmits three acknowledgment packets 81, 82 and 83 of the same content to the server 21.

On receiving the three acknowledgment packets 81 to 83, the server 21 detects the occurrence of congestion and retransmits all packets following the packet of which the reception has been acknowledged by ACK, while decreasing the amount of data transmitted per unit time.

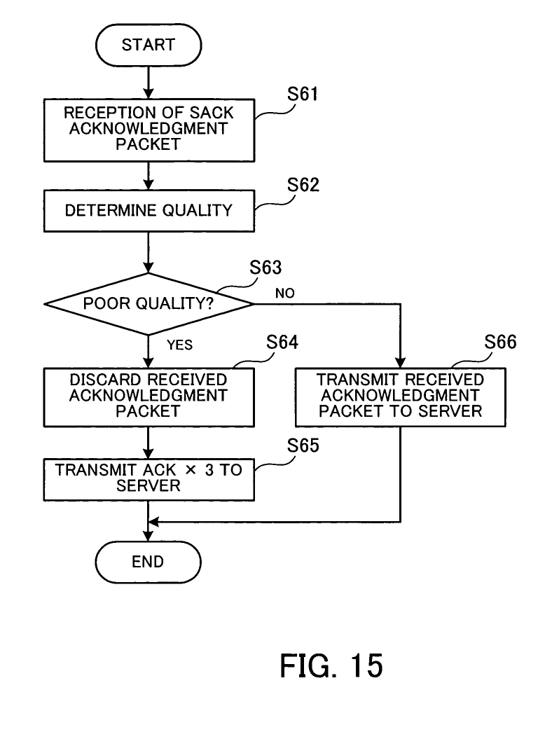

FIG. 15 is a flowchart showing a procedure for the acknowledgment packet conversion process. In the following, the process shown in FIG. 15 will be explained in order of step number.

(STEP S61) The packet analysis engine 120 receives an acknowledgment packet including SACK.

(STEP S62) The packet analysis engine 120 determines the communication quality of the transmission path 24 connected to the client 22. For example, the packet analysis engine 120 determines the communication quality by judging whether or not the frequency of occurrence of retransmission is higher than a preset threshold.

(STEP S63) If it is judged by the packet analysis engine 120 that the communication quality is poor, the process proceeds to Step S64; if it is judged that the communication quality is of satisfactory level, the process proceeds to Step S66.

(STEP S64) When the communication quality is poor, the packet analysis engine 120 discards the acknowledgment packet received in Step S61.

(STEP S65) The packet analysis engine 120 requests the ACK/SACK generation engine 130 to generate three ACK packets (ACK×3). In response to the request, the ACK/SACK generation engine 130 generates three ACK acknowledgment packets and transmits the generated packets to the server 21, whereupon the process ends.

(STEP S66) When the communication quality is of satisfactory level, the packet analysis engine 120 transmits the acknowledgment packet received in Step S61 to the server 21, followed by termination of the process.

In this manner, a SACK acknowledgment packet is converted to packets (ACK acknowledgment packet×3) requesting retransmission of packets. Consequently, when packet loss frequently occurs due to poor communication quality, a request to retransmit packets can be sent to the server 21. On receiving the packets requesting retransmission of packets, the server 21 judges that there is a transmission path of poor communication quality along the route to the client 22. In this case, the server 21 retransmits packets while decreasing the amount of data transmitted per unit time. By decreasing the amount of data transmitted per unit time, it is possible to deliver packets to the client 22 without incurring packet loss, though the communication quality of the transmission path is poor.

The acknowledgment packet conversion process may be executed concurrently with the partial data caching process. In this case, if it is judged based on the SACK information that numerous packets have been lost, the congestion control network relay device 100 starts to cache the succeeding data. Also, if the reported SACK range is wide and many of the requested packets do not exist in the cache, the network relay device sends a retransmission request (ACK packet×3) to thereby clear the congestion and expedite completion of the data caching.

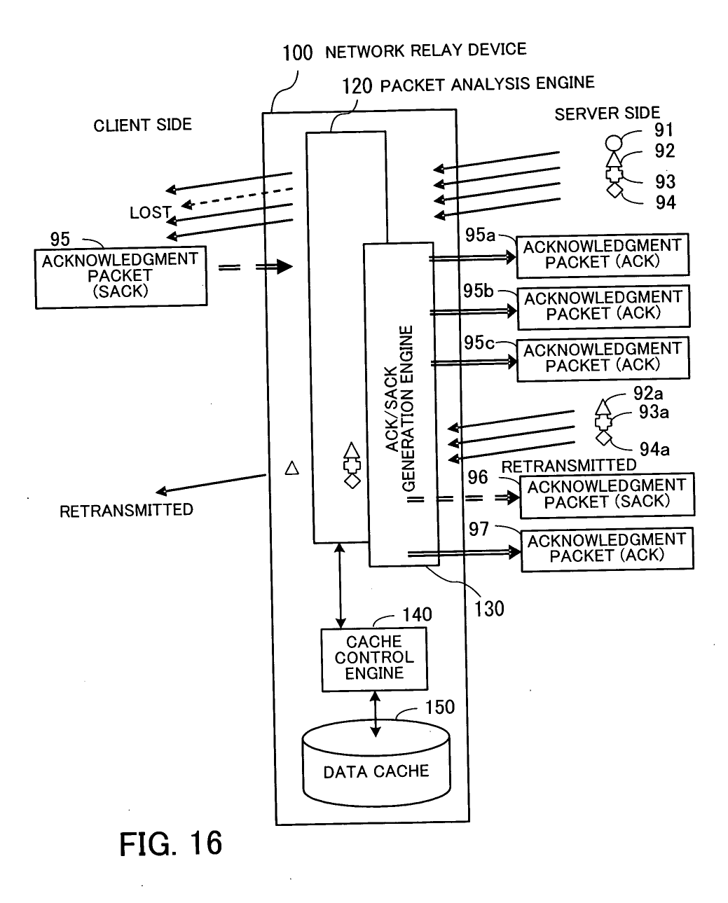

FIG. 16 exemplifies the combination of the acknowledgment packet conversion process and the partial data caching process. When packets 91 to 94 are transmitted from the server 21 to the congestion control network relay device 100, the packets 91 to 94 are transferred to the client 22 via the packet analysis engine 120. If, at this time, a packet is lost, the client 22 outputs an acknowledgment packet 95 including SACK information.

The packet analysis engine 120 analyzes the acknowledgment packet 95 and determines the communication state of the transmission path 24 connected to the client 22. Then, if it is judged that numerous packets have been lost on the transmission path 24 and also that the retransmission by means of ACK, which involves TCP congestion control, is preferable to the partial retransmission by means of SACK, the packet analysis engine 120 requests the ACK/SACK generation engine 130 to transmit a retransmission request. In response to the request, the ACK/SACK generation engine 130 successively transmits three acknowledgment packets 95a, 95b and 95c of the same content to the server 21.

On receiving the three acknowledgment packets 95a to 95c, the server 21 judges that congestion has occurred. Then, the server 21 transmits all packets following the packet of which the reception has been acknowledged by ACK, that is, retransmission packets 92a, 93a and 94a, while decreasing the amount of data transmitted per unit time.

When the retransmission packets 92a to 94a are received, the packet analysis engine 120 forwards, to the client 22, the retransmission packet 92a corresponding to the packet 92 which failed to reach the client 22. The packet analysis engine 120 discards the other retransmission packets 93a and 94a of which the reception has already been acknowledged. Also, the packet analysis engine 120 stores, in the data cache 150, data contained in the retransmission packets 92a to 94a via the cache control engine 140. Thus, only the retransmission packet 92a corresponding to the packet 92 of which the reception has not yet been acknowledged by the client 22 is transmitted to the client 22.

At this time, the packet analysis engine 120 may transmit, to the server 21 through the agency of the ACK/SACK generation engine 130, acknowledgment packets 96 and 97 for packets of which the reception has been acknowledged by ACK or SACK from the receiving side.

Exemplary Combinations of Congestion Control Processes According to Congestion States

The aforementioned processes (congestion control processes including the redundant retransmission control process, the responsive retransmission process using the data cache, the partial data caching process, and the acknowledgment packet conversion process) may be combined in various other ways than that explained above with reference to FIG. 16. For example, the processes may be combined in consideration of the purpose of the congestion control (preference for quality, speed, etc.), the receiving-side status, and the network environments. The processes to be executed are previously set in the congestion control network relay device 100 by the user.

Specifically, the congestion control processes may be switched according to congestion states in the manner described below. In an initial stage (where there is no congestion), no congestion control is performed; in an intermediate stage (after the occurrence of congestion is ascertained), the redundant retransmission control process is started; and in a terminal stage (where packet loss frequently occurs), the responsive retransmission process using the data cache is performed in combination with the acknowledgment packet conversion process (for expedited retransmission request).

Also, the congestion control processes may be switched according to the SACK status in the manner described below. When acknowledgment packets including SACK arrive infrequently (the number of packets generated per unit time is smaller than a threshold), no congestion control is performed, and when acknowledgment packets including SACK arrive frequently (the number of packets generated per unit time is larger than or equal to the threshold), the responsive retransmission process using the data cache is performed in combination with the acknowledgment packet conversion process (for expedited retransmission request).

Exemplary Methods for Determining Congestion State

To determine the congestion state, a method using RTT (Round Trip Time) may be employed, for example. RTT is the time required from the transmission of data until an acknowledgment of reception of the data is returned from the receiving side. Where the method using RTT is employed, the user previously sets a threshold for the ACK response time (RTT) of transmission data packets, and if the threshold is exceeded by RTT, the packet analysis engine 120 judges that congestion has occurred.

Also, the congestion state may be determined based on a retransmission ratio. The retransmission ratio is the ratio of retransmission-requested packets to data packets transmitted per unit time. The user sets in advance a threshold for the retransmission ratio, and if the threshold is exceeded by the retransmission ratio, the packet analysis engine 120 judges that congestion has occurred.

Examples of SACK Status Determination

A threshold for the ratio of lost packets (packets of which the reception is not acknowledged by the client 22) to the relayed packets is set by the user. Based on the SACK information, the packet analysis engine 120 calculates the ratio of lost packets to the relayed packets and, if the calculated ratio is higher than the preset threshold, judges that packets are being frequently lost.

The congestion control network relay device 100 has the function of carrying out garbage collection with respect to the session management table 111. Also, the cache control engine 140 has the function of deleting reception-acknowledged data from the data cache 150.

Further, the cache control engine 140 has the function of discarding data related with a session which is terminated in the middle, from the data cache 150. For example, if a fixed period of time elapses after an interruption of data communication, the cache control engine 140 judges that the session concerned has terminated. Alternatively, when a new session with the same client is started, the cache control engine 140 may judge that the previous session has terminated.

Advantages of the Embodiment

As seen from the above description of the embodiment, where congestion has occurred, the congestion control network relay device 100 discards unnecessary retransmission packets, thus making it possible to improve the effective communication rate of the transmission path 24 connected to the client 22. The effective communication rate referred to herein denotes the ratio of effectively communicated packets to all transmitted packets. Effectively communicated packets are the packets which were effectively used by application, while redundant retransmission packets as well as those packets which were received but not used by application due to incompletion of communication are ineffectively communicated packets.

Let us suppose the case where data of 10 packets is communicated in one session, for example. If the session is completed by communicating 10 packets only, then the effective communication rate is 100% (=10 (packets used by application)/10 (all packets)).

If five packets are retransmitted and thus a total of 15 packets are communicated, the effective communication rate is 66.7% (=10 (packets used by application)/15 (all packets)).

If communication is disrupted after the fifth packet due to error or the like, for example, the effective communication rate is 0% (=0 (packets used by application)/5 (all packets)).

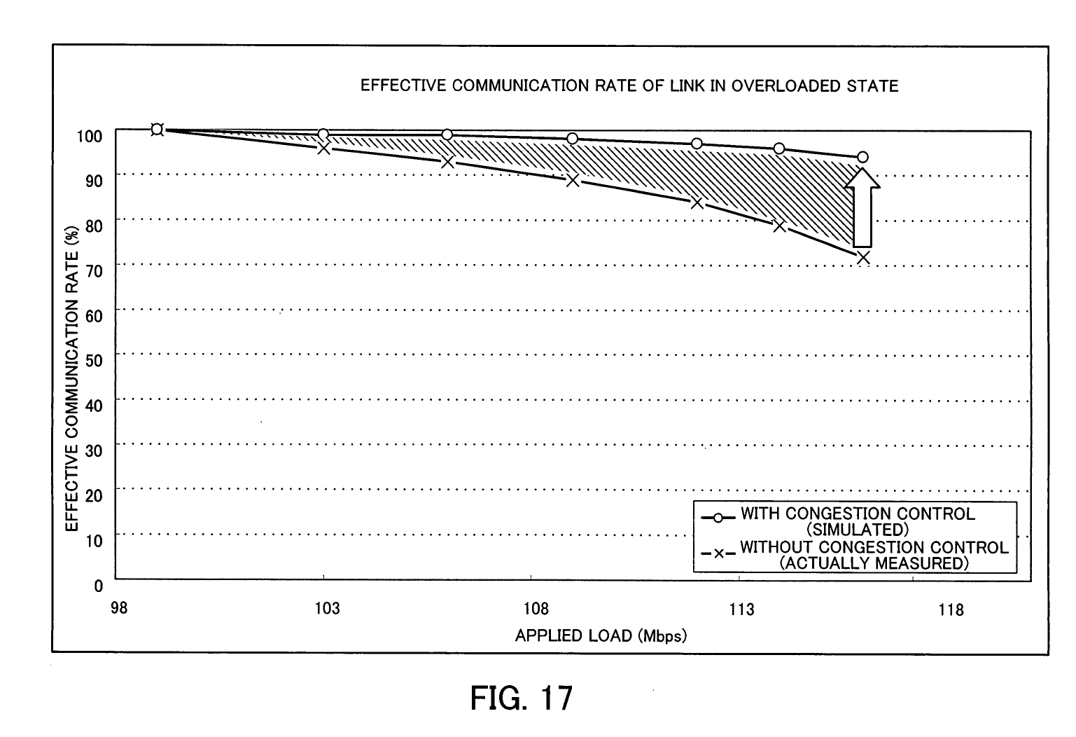

FIG. 17 is a graph showing the effective communication rate of a link in an overloaded state, in which is plotted the ratio of effectively communicated packets to all packets transmitted via a transmission path with a bandwidth of 100 Mbps, observed when the transmission path is loaded with packets exceeding the bandwidth. In the graph, the horizontal axis indicates applied load (Mbps) and the vertical axis indicates effective communication rate (%).

The graph illustrates the case where the congestion control of the embodiment was carried out (indicated by circles) and the case where the congestion control was not performed (indicated by crosses), wherein the effective communication rate was calculated based on the total number of packets transmitted per unit time and the value obtained by “the number of successful sessions×the number of packets communicated per session”.

In the simulated congestion control according to the embodiment, the number of packets discarded by the congestion control network relay device 100 was obtained to calculate the effective communication rate.

According to the embodiment, the passage of redundant packets can be prevented, as seen from the graph of FIG. 17, thus permitting effective use of the transmission path. Further, since the transmission path can be effectively used, the frequency of occurrence of congestion as well as the extent of congestion can be lowered.

Exemplary Network Systems Using the Congestion Control Network Relay Device

Apart from the first example of installation of the congestion control network relay device shown in FIG. 2, the network relay device of the embodiment can be installed in various other ways as described below. Basically, the congestion control network relay device may be installed anywhere insofar as the device is located between a server and a client communicating with each other. To effectively perform the congestion control, however, the network relay device is preferably arranged at the entry point of a transmission path on which packet loss is liable to occur due to congestion.

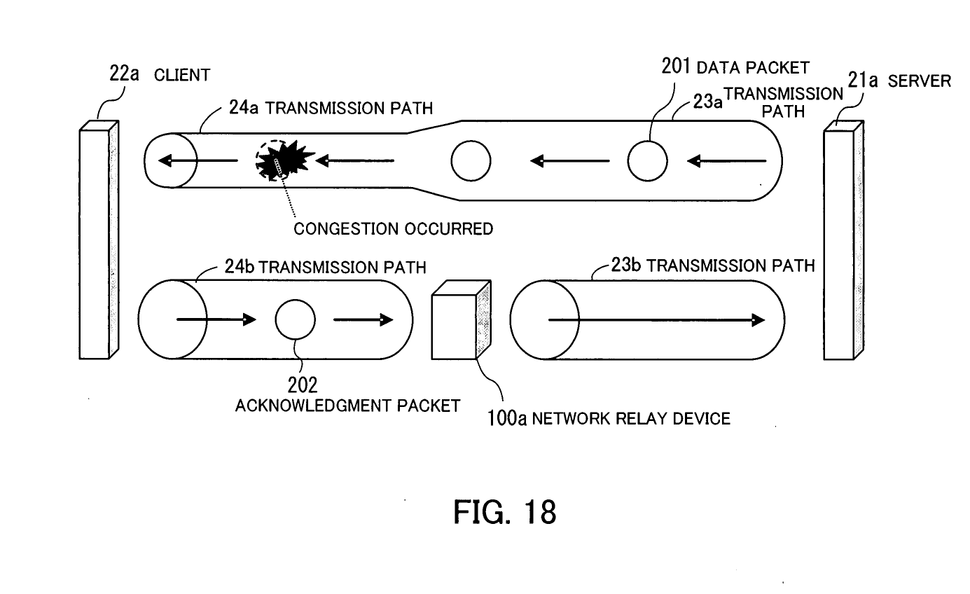

FIG. 18 shows a second example of installation of the congestion control network relay device. In this example, a transmission path is provided for each direction of transmission of packets, and a congestion control network relay device 100a is arranged on the return path (i.e., path through which ACK is returned from the client).

A data packet 201 from a server 21a is transmitted over transmission paths 23a and 24a to a client 22a. The transmission path 24a has a transmission rate lower than that of the transmission path 23a.

An acknowledgment packet 202 from the client 22a is transmitted over transmission paths 24b and 23b to the server 21a. The congestion control network relay device 100a is connected between the transmission paths 24b and 23b. The network relay device 100a has the function of performing at least the acknowledgment packet conversion process (for expedited retransmission request), besides an ordinary packet relaying function.

In the network system configured as above, the data packet 201 transmitted from the server 21a is output to the transmission path 23a and sent over the transmission path 24a. If, in this case, excessive data packets 201 are transmitted from the server 21a, congestion occurs on the transmission path 24a.

The acknowledgment packet 202 is transmitted from the client 22a and sent over the transmission path 24b to the congestion control network relay device 100a. Based on the received acknowledgment packet 202, the network relay device 100a determines the communication quality of the transmission path 24a. If it is judged that the communication quality of the transmission path 24a is poorer than a predetermined value, the network relay device 100a transmits a retransmission request (ACK×3) to the server 21a.

Thus, in the case where forward and return paths are provided for communications between a server and a client, the congestion control network relay device 100a is arranged on the return path, whereby a retransmission request can be generated early.

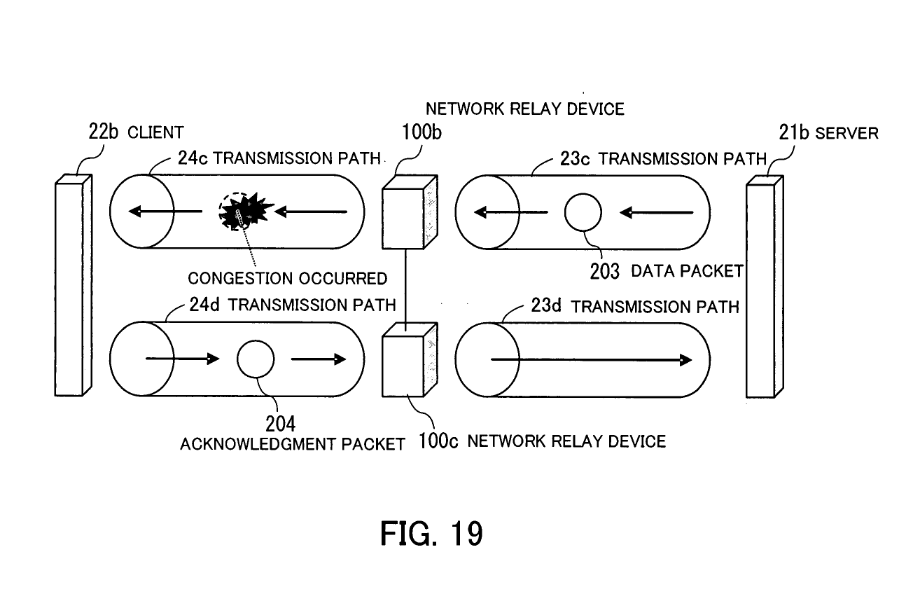

FIG. 19 shows a third example of installation of the congestion control network relay device. In this example, a transmission path is provided for each transmission direction of packets, and congestion control network relay devices 100b and 100c are provided for the respective paths.

A data packet 203 from a server 21b is transmitted to a client 22b over transmission paths 23c and 24c. The congestion control network relay device 100b is connected between the transmission paths 23c and 24c. The transmission path 24c has a transmission rate lower than that of the transmission path 23c. The network relay device 100b has the function of performing the redundant retransmission control process, the responsive retransmission process (data caching) using the data cache, and the partial data caching process (data caching), in addition to the ordinary packet relaying function.

An acknowledgment packet 204 is transmitted from the client 22b and sent over transmission paths 24d and 23d to the server 21b. The congestion control network relay device 100c is connected between the transmission paths 24d and 23d and is also connected to the network relay device 100b by a management network.

The congestion control network relay device 100c has the function of performing the responsive retransmission process (acknowledgment packet-responsive retransmission) using the data cache, the partial data caching process (communication quality determination), and the acknowledgment packet conversion process (expedited retransmission request), in addition to the ordinary packet relaying function.

In this network system, the congestion control network relay devices 100b and 100c exchange information and cooperate with each other to carry out various congestion control processes. Accordingly, although the server 21b and the client 22b communicate with each other via forward and return paths, desired congestion control processes can be carried out.

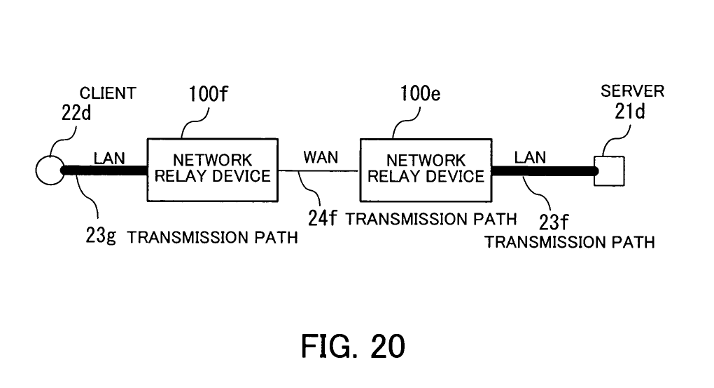

FIG. 20 shows a fourth example of installation of the congestion control network relay device. In this example, a congestion control network relay device 100f is connected to a client 22d through a high-speed transmission path 23g such as a LAN. Similarly, a congestion control network relay device 100e is connected to a server 21d through a high-speed transmission path 23f such as a LAN. The two network relay devices 100f and 100e are connected to each other by a transmission path 24f (e.g., WAN) whose transmission rate is lower than those of the transmission paths 23g and 23f.

Thus, in the case where the communication route includes the transmission path 24f with a low transmission rate, the congestion control network relay devices 100f and 100e are connected to both ends of the transmission path 24f, whereby data can be communicated efficiently in both directions.

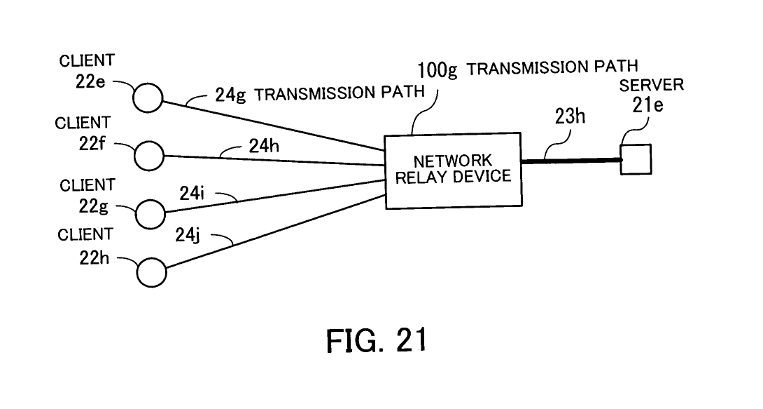

FIG. 21 shows a fifth example of installation of the congestion control network relay device. In this example, a server 21e and a congestion control network relay device 100g are connected to each other by a high-speed transmission path 23h. Also, the network relay device 100g is connected to a plurality of clients 22e to 22h via transmission paths 24g to 24j, respectively, of which the transmission rate is lower than that of the transmission path 23h. The network relay device 100g is equipped with communication interfaces corresponding in number to the transmission paths 23h and 24g to 24j.

In the network thus configured, the congestion control network relay device enables efficient communication between the clients 22e to 22h and the server 21e.

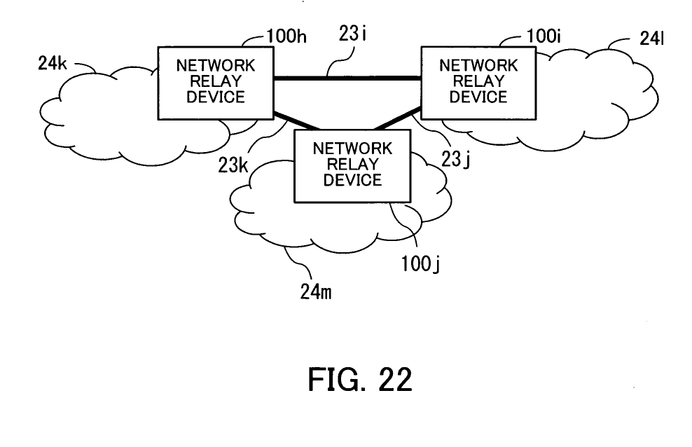

FIG. 22 shows a sixth example of installation of the congestion control network relay device. In this example, three congestion control network relay devices 100h, 100i and 100j are connected to each other by high-speed transmission paths 23i, 23j and 23k. Also, the network relay devices 100h, 100i and 100j are connected to networks 24k, 24l and 24m, respectively, in which data is communicated at lower rates than via the transmission paths 23i, 23j and 23k.

Thus, the congestion control network relay devices 100h, 100i and 100j are arranged at respective junctions between the networks 24k, 24l and 24m and the high-speed transmission paths 23i, 23j and 23k, whereby efficient communication can be performed between the various networks 24k, 24l and 24m.

Implementation of the Functions by Program

The functions described above can be performed by a computer. In this case, a program is prepared in which is described the process for performing the functions of the congestion control network relay device. The program is executed by a computer, whereupon the aforementioned functions are accomplished by the computer. The program describing the process may be recorded on computer-readable recording media. As such computer-readable recording media, magnetic recording devices, optical discs, magneto-optical recording media, semiconductor memories, etc. may be used. Magnetic recording devices include a hard disk drive (HDD), a flexible disk (FD), a magnetic tape, etc. Optical discs include a DVD (Digital Versatile Disc), a DVD-RAM (Random Access Memory), a CD-ROM (Compact Disc Read Only Memory), a CD-R (Recordable)/RW (ReWritable), etc. Magneto-optical recording media include an MO (Magneto-Optical disc) etc.

To market the program, portable recording media, such as DVDs and CD-ROMS, on which the program is recorded may be put on sale. Alternatively, the program may be stored in the storage device of a server computer and may be transferred from the server computer to other computers via a network.

A computer which is to execute the program stores in its storage device the program recorded on a portable recording medium or transferred from the server computer, for example. Then, the computer loads the program from its storage device and performs the process in accordance with the program. The computer may load the program directly from the portable recording medium to perform the process in accordance with the program. Also, as the program is transferred from the server computer, the computer may sequentially execute the process in accordance with the received program.

According to the present invention, in cases where data packets already received by the receiving-side device are retransmitted, such data packets are discarded. Thus, when congestion is caused on the transmission path connected to the receiving-side device, packets already delivered to the receiving-side device can be prevented from being redundantly retransmitted to the transmission path connected to the receiving-side device, whereby communication efficiency during congestion can be improved.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A congestion control network relay device for relaying data between a plurality of transmission paths, comprising:
acknowledgment packet detector means for detecting, from among packets transferred via the transmission paths, an acknowledgment packet by means of which a receiving-side device returns an identification number of a data packet received thereby to a transmitting-side device;
receive packet manager means for registering, in acknowledgment information memory means, the identification number of the data packet whose reception has been acknowledged by the receiving-side device, based on the acknowledgment packet detected by the acknowledgment packet detector means;
packet reception determination means for comparing an identification number of a data packet transmitted from the transmitting-side device with the identification number stored in the acknowledgment information memory means, to determine whether or not the data packet transmitted from the transmitting-side device has already been received by the receiving-side device; and
packet transfer means for discarding the data packet transmitted from the transmitting-side device if it is judged by the packet reception determination means that the data packet has already been received by the receiving-side device, and transferring the data packet transmitted from the transmitting-side device to the receiving-side device if it is judged by the packet reception determination means that the data packet has not yet been received by the receiving-side device.

2. The congestion control network relay device according to claim 1, further comprising:
caching means for caching, in a data cache, data contained in the data packet transmitted from the transmitting-side device; and
substitute retransmission means, responsive to detection of the acknowledgment packet by the acknowledgment packet detector means, for acquiring from the data cache a packet which failed to reach the receiving-side device, based on the acknowledgment packet, and transmitting the acquired packet to the receiving-side device.

3. The congestion control network relay device according to claim 2, wherein the caching means determines quality of the transmission path to the receiving-side device based on the acknowledgment packet detected by the acknowledgment packet detector means, and starts to cache data contained in the data packet if it is judged that the quality is lower than a predetermined value.

4. The congestion control network relay device according to claim 1, further comprising retransmission requesting means for determining quality of the transmission path to the receiving-side device based on the acknowledgment packet detected by the acknowledgment packet detector means, and transmitting a retransmission request to the transmitting-side device if it is judged that the quality is lower than a predetermined value.

5. A congestion control network relay program for relaying data between a plurality of transmission paths, wherein the congestion control network relay program causes a computer to function as:
acknowledgment packet detector means for detecting, from among packets transferred via the transmission paths, an acknowledgment packet by means of which a receiving-side device returns an identification number of a data packet received thereby to a transmitting-side device;
receive packet manager means for registering, in acknowledgment information memory means, the identification number of the data packet whose reception has been acknowledged by the receiving-side device, based on the acknowledgment packet detected by the acknowledgment packet detector means;
packet reception determination means for comparing an identification number of a data packet transmitted from the transmitting-side device with the identification number stored in the acknowledgment information memory means, to determine whether or not the data packet transmitted from the transmitting-side device has already been received by the receiving-side device; and
packet transfer means for discarding the data packet transmitted from the transmitting-side device if it is judged by the packet reception determination means that the data packet has already been received by the receiving-side device, and transferring the data packet transmitted from the transmitting-side device to the receiving-side device if it is judged by the packet reception determination means that the data packet has not yet been received by the receiving-side device.

6. A congestion control network relay method for relaying data between a plurality of transmission paths, comprising the steps of:
causing acknowledgment packet detector means to detect, from among packets transferred via the transmission paths, an acknowledgment packet by means of which a receiving-side device returns an identification number of a data packet received thereby to a transmitting-side device;
causing receive packet manager means to register, in acknowledgment information memory means, the identification number of the data packet whose reception has been acknowledged by the receiving-side device, based on the acknowledgment packet detected by the acknowledgment packet detector means;
causing packet reception determination means to compare an identification number of a data packet transmitted from the transmitting-side device with the identification number stored in the acknowledgment information memory means, and thereby determine whether or not the data packet transmitted from the transmitting-side device has already been received by the receiving-side device; and
causing packet transfer means to discard the data packet transmitted from the transmitting-side device if it is judged by the packet reception determination means that the data packet has already been received by the receiving-side device, and to transfer the data packet transmitted from the transmitting-side device to the receiving-side device if it is judged by the packet reception determination means that the data packet has not yet been received by the receiving-side device.
